(19) United States
(12) Patent Application Publication
(10) Pub. No.: US 2024/0145742 A1
(43) Pub. Date: May 2, 2024

(54) Fuel cell system and method for discharging water from a fuel cell system

(71) Applicant: EKPO FUEL CELL TECHNOLOGIES GMBH, Dettingen (DE)

(72) Inventors: Wadim Kaiser, Reutlingen (DE); Stefan Hemmer, Metzingen (DE); Jürgen Kraft, Metzingen (DE)

(21) Appl. No.: 18/409,426

(22) Filed: Jan. 10, 2024

Related U.S. Application Data
(63) Continuation of application No. PCT/EP2022/069307, filed on Jul. 11, 2022.

(30) Foreign Application Priority Data
Jul. 13, 2021 (DE) 10 2021 118 047.3

(51) Int. Cl. H01M 8/04119; H01M 8/04082; H01M 8/04746

(52) U.S. Cl. CPC H01M 8/04156; H01M 8/04201; H01M 8/04746

(57) ABSTRACT

In order to create a fuel cell system, comprising at least one fuel cell stack and a channel system for supplying a fluid medium to the fuel cell stack and/or for discharging a fluid medium from the fuel cell stack, a first water collection region in which water collects in a first range of operating positions of the fuel cell system, and a first water discharge port by which water is able to be discharged from the first water collection region, in which fuel cell system a drain operation is performable in any operating position of the fuel cell system, by which drain operation accumulated water is able to be discharged from the fuel cell system, it is proposed that the fuel cell system comprises at least one second water collection region in which water collects in a second range of operating positions of the fuel cell system, and at least one second water discharge port by which water is able to be discharged from the second water collection region.

### RELATED APPLICATIONS

This application is a continuation of international application number PCT/EP2022/069307 filed on 11 Jul. 2022 and claims the benefit of German application number 10 2021 118 047.3 filed on 13 Jul. 2021.

The present disclosure relates to the subject matter disclosed in international application number PCT/EP2022/069307 of 11 Jul. 2022 and German application number 10 2021 118 047.3 of 13 Jul. 2021, which are incorporated herein by reference in their entirety and for all purposes.

### FIELD OF THE DISCLOSURE

The present invention relates to a fuel cell system, comprising at least one fuel cell stack and a channel system for supplying a fluid medium to the fuel cell stack and/or for discharging a fluid medium from the fuel cell stack, a first water collection region in which water collects in a first range of operating positions of the fuel cell system, and a first water discharge port by which water is able to be discharged from the first water collection region.

The fuel cell system may comprise, in particular, polymer electrolyte membrane (PEM) fuel cells.

In the operation of such fuel cells, the water management is a decisive factor with respect to performance, operational stability, and durability of the fuel cells. The product water on the cathode side resulting from the operation of PEM fuel cells diffuses through the polymer membrane onto the anode side due to concentration gradients. In order to enable a homogeneous and sufficient supply of fluid media in the electrochemically active regions of the fuel cells, this water must be discharged in the operation of the fuel cells. This discharge of water takes place through a so-called drain operation.

The discharge of water from the channel system of the fuel cell system typically takes place by way of a drainage point, which is arranged at the lowest point of the channel system on the anode side. If the operating position of the fuel cell system changes, in particular if the fuel cell system is arranged in a vehicle and the vehicle is driving uphill, this drainage point may shift to a higher point of the channel system.

In such an operating state, the water in the channel system can then no longer be completely discharged, which, under certain circumstances, may lead to an undesired flooding of individual fuel cells or entire regions of the fuel cell stack directly or when the operating position spontaneously changes. Furthermore, when shutting off a vehicle that contains a fuel cell system, care must be taken to ensure that product water still present is completely removed from the fuel cell stack, because the water freezes at temperatures below 0° C. and over a sufficiently long standstill period. If the resulting ice is located at an unfavorable location, it may limit the supply of the fuel cell stack with fluid media when started again, which can prevent a successful cold start.

A flooding of individual fuel cells or entire regions of the fuel cells stack indirectly negatively affects the operational stability of the fuel cell system, because regions thereof that are covered with liquid water are no longer able to be sufficiently supplied with anode gas or cathode gas.

If the drainage point is not at the lowest point of the channel system, a drying procedure with a view to a potentially following cold start can thus only lead to a limited drying result, because residual water then always remains in the fuel cell system.

Furthermore, the permeability of the polymer membrane of the fuel cells leads to undesired gas diffusion processes from the cathode to the anode. Due to the presence of concentration gradients, the proportion of inert gases like, e.g., nitrogen on the anode side of the fuel cell system increases over the operating time thereof, which hinders the oxidation process and thereby reduces the electrochemical activity of the fuel cell. In order to avoid this loss of activity, the anode gas space must be flushed at regular operating intervals. Such a flushing operation is also referred to as a purge operation.

For a purge operation, the port through which the gas is flushed through the channel system of the fuel cell system must always be located in the gas space and may not be covered by water.

In addition to the previously described, rather slow concentration change processes, a spontaneous accumulation of liquid water in the gas distribution structures of the fuel cell system may occur under certain boundary conditions in the operation of the fuel cell system. These water accumulations locally reduce the supply with the anode gas or the cathode gas and must be very quickly removed from the affected regions by way of a gas pressure pulse in order to ensure the operational stability of the fuel cell system. For this purpose, typically a purge operation is performed, which generates a brief pressure gradient across the fuel cell stack. Also, when performing such a purge operation, the port through which the gas is flushed through the channel system of the fuel cell system may not be blocked by water.

In accordance with an embodiment of the invention, a fuel cell system is created in which a drain operation is performable in any operating position of the fuel cell system, by way of which drain operation accumulated water is able to discharged from the fuel cell system, and preferably a purge operation is performable in any operating position of the fuel cell system, in which purge operation a gas is flushed through the channel system of the fuel cell system.

### SUMMARY OF THE INVENTION

In accordance with an embodiment of the invention, in the case of a fuel cell system with the features of the preamble of claim 1, provision is made that the fuel cell system comprises at least one second water collection region in which water collects in a second range of operating positions of the fuel cell system, and comprises at least one second water discharge port by which water is able to be discharged from the second water collection region.

In a preferred embodiment of the fuel cell system, provision is made that the second operating position range comprises at least one second operating position partial range in which no water collects in the first water collection region. It is thus achieved that a gaseous medium is able to be flushed from the channel system through the first water discharge port when the fuel cell system is in the second operating position partial range.

Furthermore, in a particular embodiment of the invention, provision is made that the first operating position range comprises at least one first operating position partial range in which no water collects in the second water collection region. It is thus ensured that gas is able to be flushed from the channel system through the second water discharge port when the fuel cell system is located in the first operating position partial range.

It is particularly favorable if the first operating position range and the second operating position range together comprise all operating positions of the fuel cell system. It is hereby ensured that at least one of the water discharge ports for the purge of gaseous medium from the channel system of the fuel cell system is always usable.

In a preferred embodiment of the fuel cell system, provision is made that in the first operating position partial range, the lowest point of the channel system is located in the first water collection region.

Provision may further be made that in the second operating position partial range, the lowest point of the channel system is located in the second water collection region.

The first water discharge port is preferably arranged closer to an anode end plate of the fuel cell stack than to a cathode end plate of the fuel cell stack.

The second water discharge port is preferably arranged closer to a cathode end plate of the fuel cell stack than to an anode end plate of the fuel cell stack.

In a particular embodiment of the invention, provision is made that the first water discharge port and/or the second water discharge port is/are connected to a channel system for supplying an anode gas to the fuel cell stack or to a channel system for discharging an anode gas from the fuel cell stack.

Alternatively or in addition hereto, provision may be made that the first water discharge port and/or the second water discharge port is/are connected to a channel system for supplying a cathode gas to the fuel cell stack or to a channel system for discharging a cathode gas from the fuel cell stack.

It is particularly favorable if a gaseous medium is able to be discharged from the respectively associated channel system and/or is suppliable to the respectively associated channel system by the first water discharge port and/or by the second water discharge port. In this way, the first water discharge port or the second water discharge port can be used for performing a purge operation on the fuel cell system.

In a preferred embodiment of the invention, provision is made that the fuel cell system comprises a device for determining an operating position of the fuel cell system and comprises a control apparatus, which controls a first valve for closing the first water discharge port and/or a second valve for closing the second water discharge port in dependence on the determined operating position.

Such a device for determining an operating position of the fuel cell system may comprise, for example, an inclination sensor, which preferably detects an inclination of a reference plane of the fuel cell system relative to the horizontal and/or relative to the vertical.

Furthermore, in a particular embodiment of the fuel cell system, provision is made that the fuel cell system comprises a device for determining a filling state of the first water collection region and/or the second water collection region and comprises a control apparatus, which controls a first valve for closing the first water discharge port and/or a second valve for closing the second water discharge port in dependence on the determined filling state of the first water collection region and/or in dependence on the determined filling state of the second water collection region.

It is hereby possible to discharge water from the first water collection region or from the second water collection region when the respective water collection region is filled to a predetermined filling state with accumulated water.

Furthermore, by means of the first water discharge port and/or by means of the second water discharge port, a purge operation can be performed on the fuel cell system when the filling state of the first water collection region or the filling state of the second water collection region is so low that the supply of gas through the respective water discharge port is not hindered.

Such a device for determining a filling state of the first water collection region and/or of the second water collection region may comprise, in particular, a pressure sensor.

It can be concluded from the pressure profile after opening the first water discharge port or the second water discharge port whether water or gaseous medium is being discharged through the respective water discharge port.

In order to ensure that water that has accumulated in one of the water collection regions always travels into the lowest-lying water collection region, in a particular embodiment of the invention, provision is made that the first water collection region and the second water collection region are connected to one another by at least one water compensation channel.

Provision may hereby be made, for example, that at least one water compensation channel is configured as a smooth-flow region of a medium channel of a channel system of the fuel cell system.

The medium channel may be configured, in particular, to supply anode gas to the fuel cell stack or to discharge anode gas from the fuel cell stack.

The medium channel extends preferably substantially in parallel to the stack direction of the fuel cell stack.

The water compensation channel extends preferably substantially in parallel to the stack direction of the fuel cell stack.

The water compensation channel may be configured as a bulged portion on a delimiting wall of the medium channel.

Provision may further be made that at least one water compensation channel comprises two or more smooth-flow regions of a medium channel of a channel system of the fuel cell system.

Alternatively or in addition to the configuration of a water compensation channel as a smooth-flow region of a medium channel of a channel system of the fuel cell system, provision may be made that at least one water compensation channel is configured as a water compensation line formed separately from a medium channel of a channel system of the fuel cell system.

Such a water compensation line may comprise, in particular, a water compensation pipe.

The present invention further relates to a method for discharging water from a fuel cell system.

In accordance with an embodiment of the invention, a method for discharging water from a fuel cell system is created, which enables a reliable and as complete a discharge as possible of water from the fuel cell system, independently of the respective operating position of the fuel cell system.

In accordance with an embodiment of the invention, a method for discharging water from a fuel cell system is provided, which comprises the following:
collecting water in a first water collection region when the fuel cell system is in a first range of operating positions;
collecting water in a second water collection region when the fuel cell system is in a second range of operating positions;
discharging water from the first water collection region by way of a first water discharge port;
discharging water from the second water collection region by way of a second water discharge port.

The fuel cell system in accordance with the invention is suited, in particular, for performing the method in accordance with the invention for discharging water from a fuel cell system.

Particular embodiments of the method in accordance with the invention for discharging water from a fuel cell system have already been disclosed above in conjunction with particular embodiments of the fuel cell system in accordance with the invention.

The fuel cell system in accordance with the invention preferably comprises at least two water discharge ports, which are arranged adjacent to mutually averted end regions of the fuel cell stack.

Due to the condition that the first water discharge port and the second water discharge port are located at different height positions, it is always ensured, even in the unfavorable operating positions of the fuel cell system, that one of the water discharge ports is usable for the discharge of water (drain operation) and the respective other water discharge port is usable for flushing with gas (purge operation).

Independently of the respective operating position of the fuel cell system, one of the water discharge ports is always located at the lowest point of the fuel cell system. The discharge of water from the fuel cell system is thus possible in any operating position of the fuel cell system.

If one of the two water discharge ports is flooded with accumulated water, the other water discharge port is at this time always located in the gas space due to the relative geometrical arrangement of the two water discharge ports. As a result, both a drain operation and a purge operation can be successfully performed at any time and in any operating position of the fuel cell system. The drain operation and the purge operation are hereby not performed by a fixedly predetermined water discharge port, but instead are performed variably, depending on the operating position, by the respective water discharge port that is better suited for the purpose.

The detection of the current operating position of the fuel cell system and thus the associated assignment of the drain operation and the purge operation to the water discharge ports is possible, for example, by way of an inclination sensor, which is provided in the fuel cell system or in the vehicle in which the fuel cell system in arranged.

Even in the case of frequent spontaneous changes in the operating position of the fuel cell system, a reliable and complete discharge of water from the fuel cell system is always possible if the water collection regions at which the water discharge ports are arranged are connected to one another by at least one water compensation channel. A transfer of the water between the water collection regions can then take place by way of such a water compensation channel.

The transfer of water between the first water collection region and the second water collection region may take place through a medium channel of the channel system of the fuel cell system, through one or more smooth-flow regions arranged in such a medium channel, or through a water compensation line formed separately from the medium channels of the channel system of the fuel cell system.

Because in the case of the fuel cell system in accordance with the invention all the accumulated water is able to be discharged from the fuel cell system, independently of the respective operating position of the fuel cell system, the fuel cell system is prepared at all times for a cold start case that may become necessary, even when shutting off the vehicle.

A discharge of water from the fuel cell system may also take place against the gradient of the hydrostatic pressure if the prevailing operating pressure is greater than the hydrostatic pressure of the water column.

Furthermore, it is possible to always drain the water to a lowest-lying water discharge port based on the force of gravity.

A first valve that opens and closes the first water discharge port may be in fluidic connection with the cathode side of the fuel cell stack or in fluidic connection with the anode side of the fuel cell stack.

A second valve that opens and closes the second water discharge port may be in fluidic connection with the cathode side of the fuel cell stack or in fluidic connection with the anode side of the fuel cell stack.

The problem of a reliable discharge of condensed water from the fuel cell system in all possible operating positions of fuel cell stack is solved by the present invention.

The first water discharge port and the second water discharge port are arranged such that one of these water discharge ports is always located at the lowest point in the gas space of the fuel cell system, independently of the operating position of the fuel cell system. Both the discharge of water from the fuel cell system and the purging of inert gases from the fuel cell system is thus possible in any operating position of the fuel cell system.

Further features and advantages of the invention are subject matter of the subsequent description and the graphical representation of exemplary embodiments.

### BRIEF DESCRIPTION OF THE DRAWINGS

FIG. 1 shows a schematic sectional depiction of a fuel cell system, which comprises a fuel cell stack and a channel system for supplying a fluid medium to the fuel cell stack and/or for discharging a fluid medium from the fuel cell stack, a first water collection region in which water collects in a first range of operating positions of the fuel cell system, a first water discharge port by which water is able to be discharged from the first water collection region, a second water collection region in which water collects in a second range of operating positions of the fuel cell system, and a second water discharge port by which water is able to be discharged from the second water collection region;

FIG. 2 shows a cross section taken perpendicularly to a stack direction of the fuel cell stack from FIG. 1 through a medium channel of the channel system of the fuel cell system, wherein the medium channel has a smooth-flow region, which serves as a water compensation channel that connects the first water collection region and the second water collection region to one another;

FIG. 3 shows a schematic sectional depiction corresponding to FIG. 1 of the fuel cell system from FIGS. 1 and 2 in an alternative operating position of the fuel cell system in which the first water collection region is located lower than the second water collection region;

FIG. 4 shows a graph, which shows the pressure profile as a function of time t determined by the pressure sensor of the fuel cell system in the channel system, wherein opening phases of a first valve by which water is able to be discharged from the first water collection region, and a second valve by which water is able to be discharged from the second water collection region are depicted, and wherein a reference value pᵣ for the pressure p is shown, which is determined from the pressure profile during an opening phase of the first valve, and the second valve is closed before reaching a predetermined opening time T when the pressure determined after opening the second valve reaches the reference value;

FIG. 5 shows a graph corresponding to FIG. 4, which shows the pressure profile as a function of time t determined by means of the pressure sensor, the opening phases of the first valve and the second valve being depicted simultaneously, and wherein the pressure reference value is adapted after a change in the operating conditions of the fuel cell stack;

FIG. 6 shows a graph corresponding to FIGS. 4 and 5, which shows the pressure profile as a function of time t determined by means of the pressure sensor, the opening phases of the first valve and the second valve being depicted simultaneously, and a change in the pressure level with closed valves is brought about by a change in the operating conditions of the fuel cell system, wherein the pressure reference value is adapted after a change in this pressure level with closed valves;

FIG. 7 shows a depiction corresponding to FIGS. 4 to 6 of the pressure profile as a function of time t determined by means of the pressure sensor, wherein it is determined from the pressure profile during an opening phase of the first valve that the first valve is in an irregular operating state, the second valve then being opened instead of the first valve, such that the second valve takes on the function of the first valve;

FIG. 8 shows a depiction corresponding to FIGS. 4 to 7 of the pressure profile as a function of time t determined by means of the pressure sensor, wherein the reference value pᵣ for the pressure determined from the pressure profile during an opening phase of the first valve is higher than in the control method depicted in FIG. 4;

FIG. 9 shows a depiction corresponding to FIGS. 4 to 8 of the pressure profile as a function of time t determined by means of the pressure sensor, wherein the reference value pᵣ for the pressure determined from the pressure profile during an opening phase of the first valve is lower than the reference value that is determined in the control method according to FIG. 4, and is lower than the minimum pressure during the opening phase of the first valve;

FIG. 10 shows a schematic cross section corresponding to FIG. 2 through a medium channel of the channel system of a second embodiment of the fuel cell system, in which embodiment the medium channel has two smooth-flow regions, which each serve as a water compensation channel that connects the first water collection region and the second water collection region to one another; and

FIG. 11 shows a schematic cross section corresponding to FIGS. 2 and 10 through a medium channel of the channel system of a third embodiment of the fuel cell system and a water compensation channel, which connects the first water collection region and the second water collection region to one another and is configured as a water compensation line formed separately from the medium channel.

### DETAILED DESCRIPTION OF THE INVENTION

The same or functionally equivalent elements are provided with the same reference numerals in all Figures.

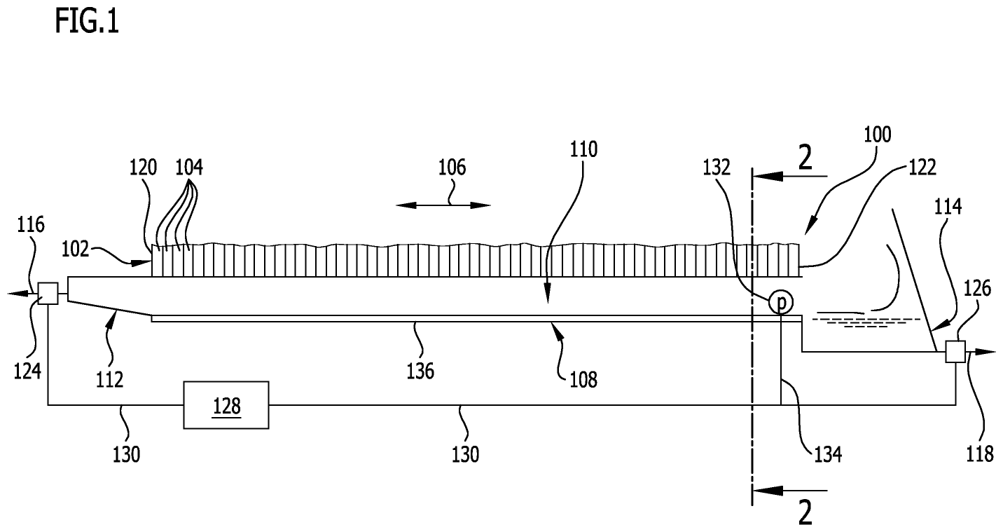

A fuel cell system depicted in FIGS. 1 to 3 and denoted as a whole with 100 comprises a fuel cell stack 102, which comprises a plurality of fuel cells 104 that succeed one another along a stack direction 106.

In the operating position of the fuel cell system 100 depicted in FIG. 1, which corresponds to a standard position of the fuel cell system 100, the stack direction 106 is oriented substantially horizontally.

The fuel cell system 100 further comprises a channel system 108 for supplying a fluid medium to the fuel cell stack 102 and/or for discharging a fluid medium from the fuel cell stack 102.

The fluid medium may be an anode gas or a cathode gas of the fuel cell system 100.

Depicted in FIG. 1 is a medium channel 110 of the channel system 108 through which, for example, an anode gas of the fuel cell system 100 is guided.

The medium channel 110 extends substantially along the stack direction 106.

During the operation of the fuel cell system 100, water accumulates in the medium channel 110.

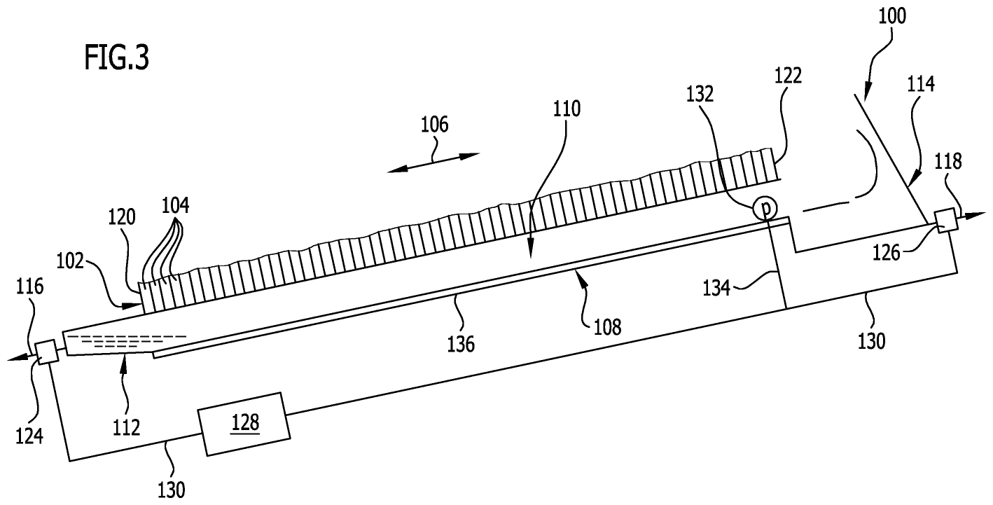

For collecting this water accumulating in the medium channel 110, the fuel cell system 100 comprises at least one first water collection region 112 in which water collects in a first range of operating positions of the fuel cell system 100 (see FIG. 3 in which the fuel cell system 100 is inclined relative to the standard operating position depicted in FIG. 1), and comprises a second water collection region 114 in which water collects in a second range of operating positions of the fuel cell system 100 (see the standard operating position of the fuel cell system 100 depicted in FIG. 1).

The fuel cell system 100 further comprises a first water discharge port 116 by which water is able to be discharged from the first water collection region 112, and a second water discharge port 118 by which water is able to be discharged from the second water collection region 114.

For example, provision may be made that the first water discharge port 116 is arranged closer to an anode end plate 120 than to a cathode end plate 122 of the fuel cell stack 102, and that the second water discharge port 118 is arranged closer to the cathode end plate 122 than to the anode end plate 120 of the fuel cell stack 102.

In principle, the arrangement of the first water discharge port 116 and the arrangement of the second water discharge port 118 could also be switched with one another, such that the first water discharge port 116 would then be arranged closer to the cathode end plate 122 of the fuel cell stack 102 than to the anode end plate 120 of the fuel cell stack 102 and the second water discharge port 118 would be arranged closer to the anode end plate 120 of the fuel cell stack 102 than to the cathode end plate 122 of the fuel cell stack 102.

The fuel cell system 100 further comprises a first valve 124 by means of which the first water discharge port 116 can be opened or closed, and a second valve 126 by means of which the second water discharge port 118 can be opened or closed.

Furthermore, the fuel cell system 100 comprises a control apparatus 128, which is connected to the first valve 124 and the second valve 126 by way of one or more control lines 130 in order to be able to control the first valve 124 and the second valve 126.

Furthermore, the fuel cell system 100 comprises a pressure sensor 132 by means of which a profile of a pressure p in the channel system 108 is determinable. The pressure sensor 132 is also connected to the control apparatus 128 by way of a control line 134.

The first water collection region 112 and the second water collection region 114 of the fuel cell system 100 are connected to one another by at least one water compensation channel 136 through which water, depending on the current operating position of the fuel cell system 100, is able to flow from the respective higher-lying water collection region into the respective lower-lying water collection region.

In the standard operating position of the fuel cell system 100, which is depicted in FIG. 1, the first water collection region 112 is located higher than the second water collection region 114, such that in this operating position, water would flow from the first water collection region 112 through the water compensation channel 136 into the second water collection region 114.

In the alternative operating position of the fuel cell system 100 depicted in FIG. 3, the second water collection region 114 is located higher than the first water collection region 112, such that in this operating position, water would flow from the second water collection region 114 through the water compensation channel 136 into the first water collection region 112.

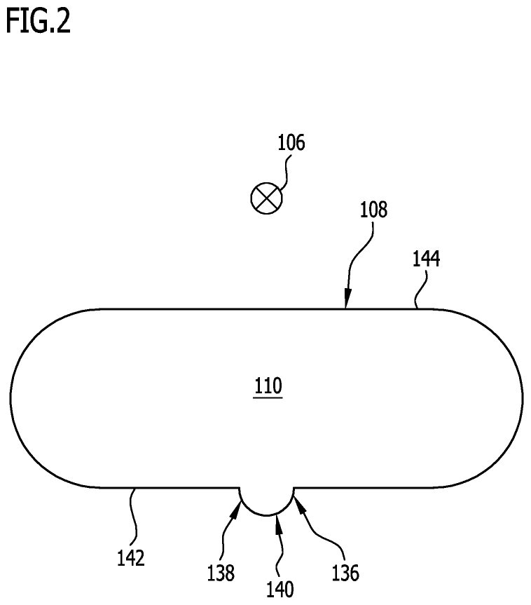

As can be seen from the cross section through the medium channel 110 of the channel system 108 of the fuel cell system 100 in FIG. 2, the water compensation channel 136 may comprise a smooth-flow region 138 of the medium channel 110.

Such a smooth-flow region 138 may be configured, for example, as a protrusion 140, which is arranged at a base region 142 of a delimitation 144 of the medium channel 110 located at the bottom in the direction of gravity.

Due to the configuration of the fuel cell system 100 with the two water collection regions 112 and 114, it is ensured that in any operating position of the fuel cell system 100, in each case at least one of the water discharge ports 116 and 118 opens at a water collection region 112 or 114 that is not filled with water, such that a gaseous medium is able to be discharged from the channel system by the corresponding water discharge port 116 or 118. This function is required in order to perform a so-called purge operation or flushing operation on the fuel cell system 100.

If there is liquid water in the channel system 108, this water thus always collects in the first water collection region 112 or in the second water collection region 114, such that it is always possible to discharge the water from the channel system 108 (so-called drain operation or water discharge operation) by opening the first valve 124 at the first water discharge port 116 or by opening the second valve 126 at the second water discharge port 118.

In order to determine which of the valves 124, 126 must be opened by the control apparatus 128 to perform a drain operation, provision may be made, for example, that the fuel cell system 100 comprises a device (not depicted) for determining an operating position of the fuel cell system 100. Such a device for determining an operating position of the fuel cell system 100 may comprise, for example, an inclination sensor.

In dependence on the operating position determined by the device for determining an operating position of the fuel cell system 100, the control apparatus 128 then opens either the first valve 124, by way of which the first water discharge port 116 is closable, or the second valve 126, by way of which the second water discharge port 118 is closable, for performing a drain operation.

For performing a purge operation, the control apparatus 128 then opens the respective other one of the two valves 124, 126.

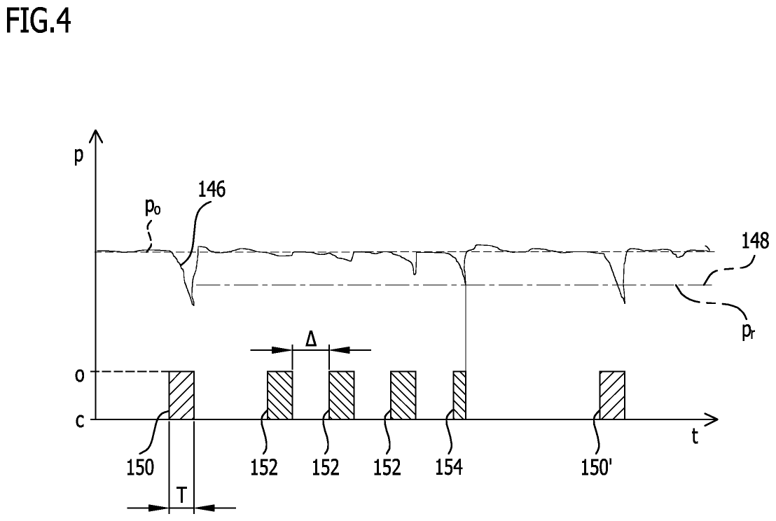

A method for controlling the operation of the above-described fuel cell system 100 by means of the control apparatus 128 is schematically depicted in FIG. 4.

FIG. 4 represents a profile 146 of the pressure p in the channel system 108 determined by means of the pressure sensor 132 as a function of time t.

Furthermore, the respective state of the first valve 124 and the second valve 126 as a function of time t is shown in FIG. 4. Each of the valves 124 and 126 can be switched by means of the control apparatus 128 from a closed state (“c” in FIG. 4) into an open state (“o” in FIG. 4) and remains for a predetermined time T in the open state in which a liquid or gaseous medium is able to pass through the respective valve 124 or 126 until it is closed again by the control apparatus 128.

If a certain event occurs in the pressure profile 146, for example reaching a pressure reference value 148, the control apparatus 128 closes the valve 124 or 126 in the opening phase at the corresponding time before expiration of the predetermined opening time T.

The predetermined opening time T may be the same for both valves 124 and 126 or may be different for the two valves 124 and 126.

The opening phases of the first valve 124 are shown in FIG. 4 by a first hatching, which has lines running from the bottom left to the top right.

The opening phases of the second valve 126 are shown in FIG. 4 by a second hatching, which has lines running from the top left to the bottom right.

As can be seen in FIG. 4, the pressure prevailing in the channel system 108 before opening the first valve 124 is at an average value p₀, with small random fluctuations.

By opening the first valve 124 in a first opening phase 150 of the first valve 124, gaseous medium travels from the first water collection region 112, which contains no water at this time, out of the channel system 108, the pressure p determined by means of the pressure sensor 132 thereby dropping significantly until the first valve 124 is closed again after the predetermined opening time T. The pressure p in the channel system 108 then increases again up to the initial pressure p₀.

From the pressure profile 146 between the opening and closing of the first valve 124 with which a purge operation was performed, a pressure reference value pᵣ is determined, which is used by the control apparatus 128 for controlling the closing of the second valve 126 in the course of a drain operation.

The drain operation by which water accumulated in the second water collection region 114 is discharged from the channel system 108 begins with a sequence of opening phases 152 of the second valve 126, during which the pressure reference value pᵣ is not reached.

Each of these opening phases 152 therefore ends after the predetermined opening time T.

These opening phases succeed one another at a predetermined time interval Δ.

The drop of the pressure p in the channel system 108 is significantly smaller during the opening phases 152 of the second valve 126 than the pressure drop during the opening phase 150 of the first valve 124, because the water discharged during the opening phases 152 of the second valve 126 has a significantly higher viscosity than the gaseous medium discharged during the opening phase 150 of the first valve 124.

However, with increasing emptying of the second water collection region 114 through the successive drain phases, an increasing amount of gaseous medium is discharged together with the water from the second water collection region 114, such that the pressure drop continues to increase during an opening phase 152.

After a plurality of opening phases 152 in which the pressure reference value pᵣ is not reached, an opening phase 154 of the second valve 126 then follows, in the course of which the pressure p reaches the pressure reference value pᵣ, which triggers a closing of the second valve 126 by the control apparatus 128, such that the opening phase 154 is terminated prematurely, i.e. before expiration of the predetermined opening time T.

Alternatively hereto, provision may also be made that the second valve 126 remains open for the entire predetermined opening time T and reaching the pressure reference valve pᵣ only has the effect that no further opening phase is performed.

The pressure reference value pᵣ is determined from the pressure profile during the opening phase 150 of the first valve 124 such that it can be concluded with high probability from reaching this pressure reference value pᵣ that substantially no more water to be discharged is found in the second water collection region 114.

The operation of the fuel cell system 100 is then continued by the control apparatus 128 with a further opening phase 150′ of the first valve 124, by which a purge operation is performed. As long as the operating conditions of the fuel cell system 100 do not change significantly, the pressure reference value pᵣ determined in the preceding opening phase 150 of the first valve 124 is not redetermined from the pressure profile during the opening phase 150′ of the first valve 124, but instead is maintained unchanged.

The opening phase 150′ of the first valve 124 is then followed again by drain operation (not depicted), which comprises a plurality of complete opening phases 152 of the second valve 126 and a prematurely terminated opening phase 154 of the second valve 126.

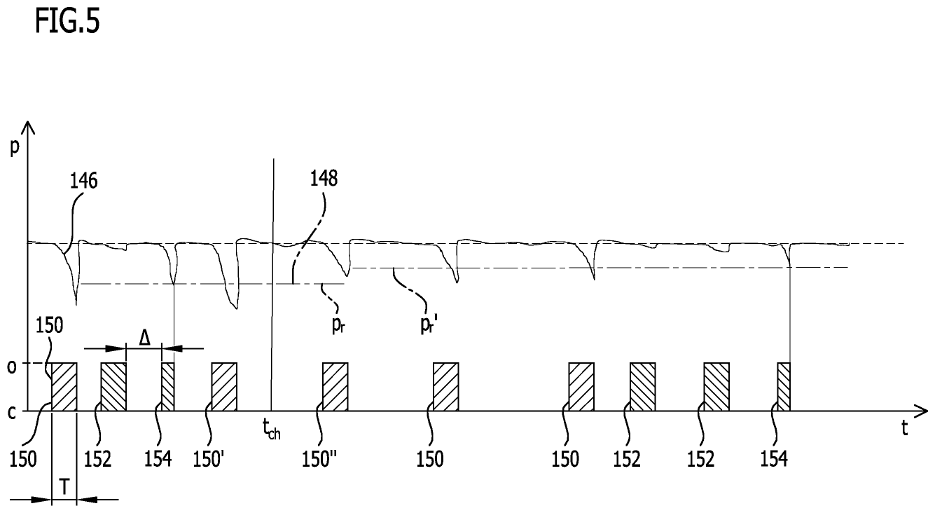

FIG. 5 shows the control of the operation of the fuel cell system 100 in a case in which a significant change in the operating conditions of the fuel cells system 100 occurs between two purge operations, namely at a time t_{ch}.

First, the control method proceeds as depicted in FIG. 4 and already explained above with reference to FIG. 4.

During a first opening phase 150 of the first valve 124, a pressure reference value pᵣ is determined and then used for the control of the second valve 126 by the control apparatus 128.

A drain operation is performed by the control apparatus 128, which in this case comprises only one complete opening phase 152 and one prematurely terminated opening phase 154, wherein the prematurely terminated opening phase 154 is terminated upon reaching the pressure reference value pᵣ.

Then, the control apparatus 128 performs a purge operation by opening the first valve 124 during an opening phase 150′, wherein during the purge operation, the pressure p in the channel system 108 drops below the pressure reference value pᵣ, which indicates that no recalibration of the pressure reference value pᵣ is necessary.

At a time t_{ch}, the operating conditions of the fuel cell system 100 change such that in a subsequent opening phase 150″ of the first valve 124, the pressure p in the channel system 108 no longer drops down to the pressure reference value pᵣ.

This indicates to the control apparatus 128 that the pressure reference value needs to be redetermined from the pressure profile during the opening phase 150″.

As can be seen in FIG. 5, the new pressure reference value pᵣ′ is determined such that it is higher than the previous pressure reference value pᵣ, but still lower than the initial pressure p₀.

In a subsequent opening phase 150 during a further purge operation, the pressure p in the channel system 108 reaches the adapted pressure reference value pᵣ′, which indicates to the control apparatus 128 that no further change to the pressure reference value pᵣ′ is necessary.

The same applies to the next opening phase 150 of the first valve 124 in a further purge operation.

The control apparatus 128 then performs a drain operation by means of the second valve 126, which comprises a plurality of complete opening phases 152 of the second valve 126 and a prematurely terminated opening phase 154, which is terminated by reaching the adapted pressure reference value pᵣ′.

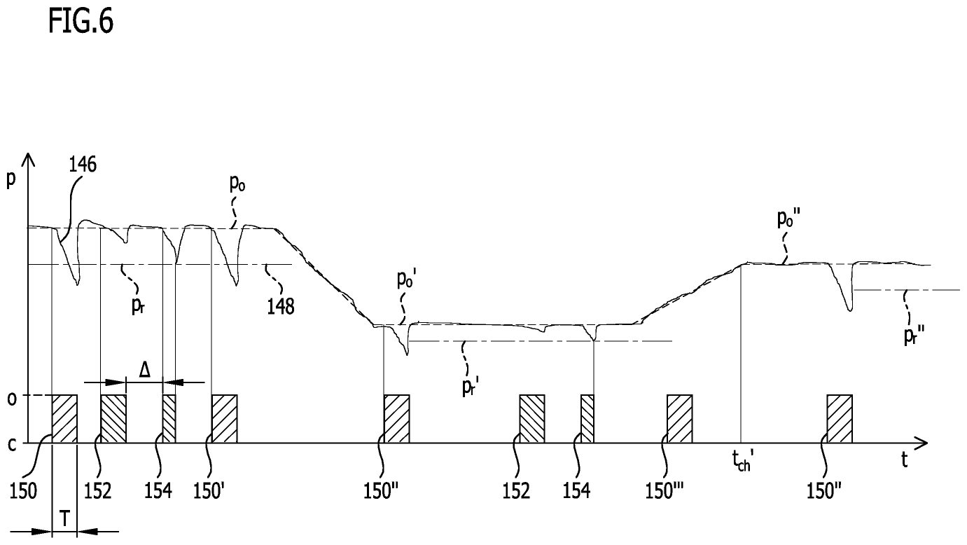

FIG. 6 shows the control of the operation of the fuel cell system 100 in a case in which a change in the pressure level p₀ with closed valves is brought about by a change in the operating conditions of the fuel cell system, wherein the pressure reference value pᵣ is adapted after detection of a change in the pressure level p₀ with closed valves.

The control method according to FIG. 6 initially proceeds as already depicted in FIG. 4 and explained above with reference to FIG. 4.

During a first opening phase 150 of the first valve 124, a pressure reference value pᵣ is determined and then used for the control of the second valve 126 by the control apparatus 128.

A drain operation is performed by the control apparatus 128, wherein in this case the drain operation comprises a complete opening phase 152 and a prematurely terminated opening phase 154. Here, the prematurely terminated opening phase 154 is terminated upon reaching the pressure reference value pᵣ.

Then, the control apparatus 128 performs a purge operation by opening the first valve 124, wherein during the purge operation, the pressure p in the channel system 108 drops below the pressure reference value pᵣ, which indicates that no recalibration of the pressure reference value pᵣ is necessary.

After this purge operation, the operating conditions of the fuel cell system 100 change in such a way that in a subsequent opening phase 150″ of the first valve 124, the initial pressure p₀′ is lower than the original initial pressure p₀ with closed valves 124 and 126 and also lower than the previous pressure reference value pᵣ.

This indicates to the control apparatus 128 that the pressure reference value needs to be redetermined from the pressure profile during the opening phase 150″.

As can be seen in FIG. 6, the new pressure reference value pᵣ′ is determined such that it is lower than the new initial pressure value pᵣ and is lower than the previous pressure reference value pᵣ.

A drain operation is then performed by the control apparatus 128, wherein the drain operation comprises, for example, a complete opening phase 152 and a prematurely terminated opening phase 154. Here, the prematurely terminated opening phase 154 is terminated upon reaching the new pressure reference value pᵣ′.

After this drain operation, the operating conditions of the fuel cell system 100 change again, namely in such a way that in a subsequent opening phase 150′″ of the first valve 124, the pressure p in the channel system 108 does not drop, but instead increases further during the opening phase 150′″.

This indicates to the control apparatus 128 that the fuel cell system 100 is currently in a changing phase in which the operating conditions of the fuel cell system 100 change such that the initial pressure value p₀ changes compared to the preceding equilibrium operation phase, namely in particular increases.

After the time t_{ch}′, a new stable operating state of the fuel cell system 100 is reached in which the initial pressure value p₀″ with closed valves 124 and 126 is again substantially constant.

The new initial pressure value p₀″ may be, e.g., between the first initial pressure value p₀ and the second initial pressure value p₀′.

If a purge operation is now performed by the control apparatus 128 by opening the first valve 124, the pressure p in the channel system 108 then drops starting from the new initial pressure value p₀″, which indicates to the control apparatus 128 that the pressure reference value must be redetermined from the pressure profile during this opening phase 150″.

As can be seen in FIG. 6, the new pressure reference value pᵣ″ is determined from the pressure profile during the opening phase 150″ such that it is higher than the preceding pressure reference value pᵣ′ and is higher than the preceding initial pressure value p₀′.

This newly adapted pressure reference value pᵣ″ is then used by the control apparatus 128 for the control of the second valve 126 in a drain operation.

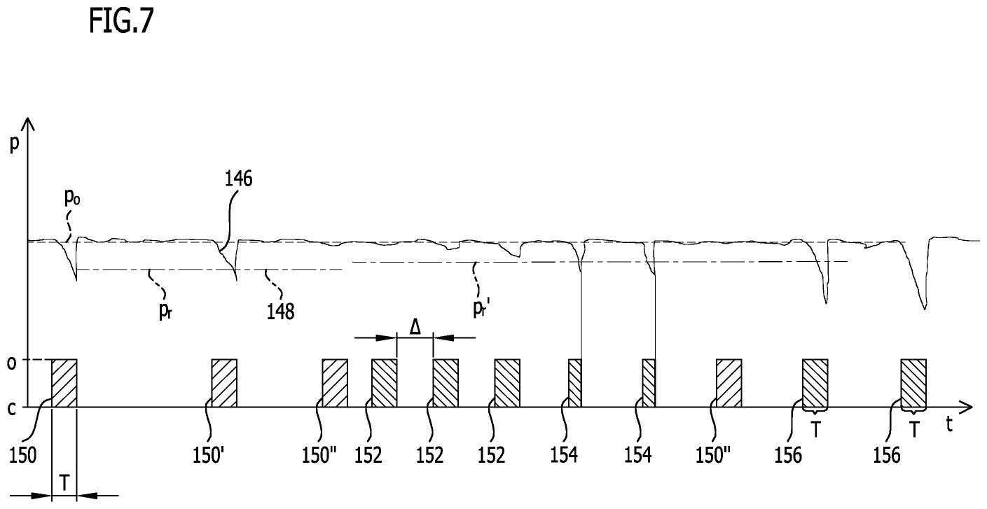

FIG. 7 shows the control of the operation of the fuel cell system 100 in a case in which it is determined from the pressure profile during an opening phase of the first valve 124 that the first valve 124 is in an irregular operating state, the second valve 126 therefore then being opened instead of the first valve 124 in order to perform a purge operation using the second valve 126.

The fuel cell system 100 is initially in a regular operating state in which the first water collection region 112 is filled with gaseous medium, such that a purge operation is able to be performed by opening the first valve 124.

A pressure reference value pᵣ is determined during a first opening phase 150 of the first valve 124.

In a subsequent second opening phase 150′ of the first valve 124, the pressure p in the channel system 108 drops below the pressure reference value pᵣ, which indicates to the control apparatus 128 that a recalibration of the pressure reference value pᵣ is not necessary.

In a further opening phase 150″ of the first valve 124, the pressure p in the channel system 108 does not drop or drops only to an insignificant extent, which indicates to the control apparatus 128 that a purge operation is not performable by means of the first valve 124, because the first valve 124 is clogged or iced over, or the first water collection region 112 is filled with water, such that no gaseous medium is able to be discharged from the channel system 108 by means of the first valve 124.

The control apparatus 128 then adapts the pressure reference value pᵣ to a higher value pᵣ′.

The control apparatus 128 then first performs a drain operation by opening the second valve 126.

This drain operation comprises, in this case performed by way of example, three complete opening phases 152 and a prematurely terminated opening phase 154. Here, the prematurely terminated opening phase 154 of the second valve 154 is terminated upon reaching the pressure reference value pᵣ.

After this first drain operation, the control operation 128 performs a second drain operation using the second valve 126, which comprises only a prematurely terminated opening phase 154, because there is only a small amount of water in the second water collection region 114, such that the pressure reference value pᵣ is reached after only a short time and as a result the opening phase 154 is prematurely terminated.

The control apparatus 128 then again initiates a purge operation by opening the first valve 124. During the opening phase 150″ of the first valve 124, the pressure p in the channel system 108 again does not drop or drops only to an insignificant extent, which indicates to the control apparatus 128 that still no purge operation is performable by means of the first valve 124, for example because the first valve 124 is still clogged, is still iced over, or the first water collection region 112 is still filled with water.

The control apparatus 128 then performs a purge operation using the second valve 126, said operation not being performable by means of the first valve 124.

The second valve 126 is hereby opened, wherein the opening phase 156 of the second valve 126 in this case is not terminated when the pressure reference value pᵣ is reached, but instead the opening phase 156 of the second valve 126 is continued until the entire predetermined opening time T has elapsed.

A comparatively large amount of gaseous fluid is hereby discharged from the channel system 108 through the second valve 126 working as a purge valve.

At a later time, the control apparatus 128 again performs a purge operation by opening the second valve 126 instead of the first valve 124. Here, the second valve 126 again remains open past the time at which the pressure p in the channel system 108 has dropped to the pressure reference value pᵣ, until the predetermined opening time T has completely elapsed.

At a later time (not longer shown), the control apparatus 128 can again attempt to perform a purge operation by means of the first valve 124 in order to determine whether the first valve 124 has returned to a regular operating state.

Alternatively or in addition hereto, the control apparatus 128 can perform a drain operation by means of the first valve 124 at a later time (not shown) in order to discharge water from the first water collection region 112, wherein for this purpose, the control apparatus 128 controls the first valve 124 during the drain operation as it would normally control the second valve 126 for performing a drain operation.

In the methods for controlling the operation of the fuel cell system 100, which have been shown in FIGS. 4 to 7, it has been assumed that the channel system 108 with the two valves 124 and 126 is of substantially symmetrical configuration with respect to flow, which means that the gas paths through the first valve 124 and through the second valve 126, under otherwise equal conditions, generate substantially the same pressure loss with equally long opening phases. This does not necessarily mean that the two valves 124 and 126 are strictly geometrically symmetrical.

In one variant of the above-described fuel cell system 100, provision may be made that the first valve 124 and the second valve 126 of the fuel cell system 100 are not of symmetrical configuration with respect to flow, which means that the gas paths through the first valve 124 and the second valve 126 are configured such that equally long opening phases of the first valve 124 and the second valve 126 result in different pressure losses when being flowed through by a gas.

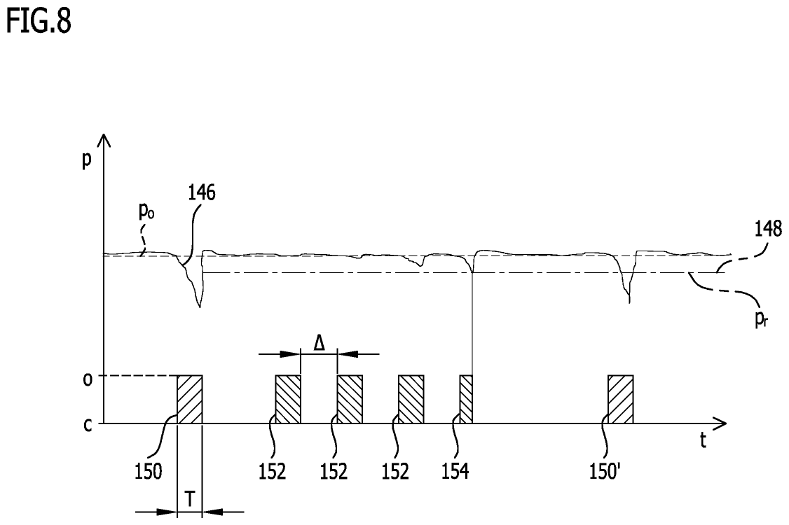

Depicted in FIG. 8 is the case in which the opening of the second valve 126 results in a smaller pressure loss than an opening of the first valve 124 when being flowed through by gas.

This may be caused, for example, by the fact that the second valve 126 has a smaller cross section that can be flowed through in order to reduce the through-flow streams and pressure fluctuations that occur when performing a drain operation.

As in the control method depicted in FIG. 4, in the case of the control method according to FIG. 8, too, the pressure prevailing in the channel system 108 before the opening of the first valve 124 is at an average value p₀, with small operational fluctuations.

By opening the first valve 124 in a first opening phase 150 of the first valve 124, gaseous medium travels from the first water collection region 112, which contains no water at this time, out of the channel system 108, the pressure p determined by means of the pressure sensor 132 thereby dropping significantly until the first valve 124 is closed again after the predetermined opening time T. The pressure p in the channel system 108 then increases again up to the initial pressure p₀.

From the pressure profile 146 between the opening and closing of the first valve 124 with which a purge operation was performed, a pressure reference value pᵣ is determined, which is used by the control apparatus 128 for controlling the closing of the second valve 126 in the course of a drain operation.

Due to the asymmetry of the gas paths through the first valve 124 and through the second valve 126, in the case of this control method, the pressure reference value pᵣ determined by the control apparatus 128 is still closer to the initial pressure p₀ than in the case of the control method depicted in FIG. 4, which is preferably used with valves 124 and 126 with a symmetrical configuration with respect to flow.

A drain operation is then performed by the control apparatus 128, which, in this case depicted as an example in FIG. 8, comprises three complete opening phases 152 and a prematurely terminated opening phase 154, wherein the prematurely terminated openings phase 154 is terminated upon reaching the pressure reference value pᵣ.

Then, the control apparatus 128 performs a purge operation by opening the first valve 124, wherein during the purge operation, the pressure p in the channel system 108 drops below the pressure reference value pᵣ, which indicates that no recalibration of the pressure reference value pᵣ is necessary.

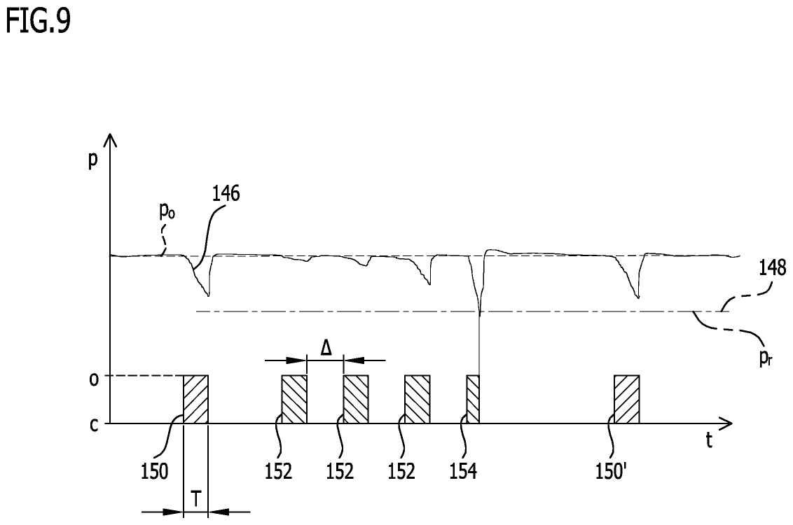

A control method depicted in FIG. 9 for controlling the operation of the fuel cell system 100 differs from the control method depicted in FIG. 8 in that the pressure reference value pᵣ determined from the pressure profile during the opening phase 150 of the first valve 124 is further away from the initial pressure value p₀ than the maximum pressure loss during the opening phase 150.

This is useful if the gas path through the second valve 126 is configured such that an opening of the second valve 126 results in a greater pressure drop in the channel system 108 than an opening of the first valve 124 when being flowed through by gas and under otherwise identical conditions.

This may be caused, for example, by the second valve 126 having a greater nominal width than the first valve 124, with otherwise conducting elements.

The pressure reference value pᵣ determined from the pressure profile during the first opening phase 150 of the first valve 124 is then used for the control of the second valve 126 by the control apparatus 128.

A drain operation is then performed by the control apparatus 128, which in the case depicted as an example in FIG. 9 comprises three complete opening phases 152 and a prematurely terminated opening phase 154, wherein the opening phase 154 is prematurely terminated upon reaching the pressure reference value pᵣ.

Then, the control apparatus 128 performs a purge operation by opening the first valve 124, wherein during the purge operation, the pressure p in the channel system 108 does not drop below the pressure reference value pᵣ, but still substantially reaches the minimum pressure during the first opening phase 150 of the first valve 124, which indicates to the control apparatus 128 than a recalibration of the pressure reference value pᵣ is not necessary.

In the control method from FIG. 8, the deviation of the pressure reference value pᵣ from the initial pressure value p₀ is thus smaller by a translation factor, the value of which is smaller than 1, than the difference between the pressure reference value pᵣ and the initial pressure value p₀ in the case depicted in FIG. 4 of a symmetrical configuration of the channel system 108 and the two valves 124 and 126 with respect to flow.

By contrast, in the control method depicted in FIG. 9, the difference between the pressure reference value pᵣ and the initial pressure value p₀ is greater by a translation factor that is greater than 1 than the deviation of the pressure reference value pᵣ from the initial pressure value p₀ in the case depicted in FIG. 4 of a symmetrical configuration of the channel system 108 and the two valves 124 and 126 with respect to flow.

The respective translation factor that is used by the control apparatus 128 in the asymmetrical configuration of the channel system 108 and/or the two valves 124 and 126 can be determined through a pre-calibration and be checked during the operation of the fuel cell system 100 and adapted as necessary.

In all other respects, the control methods depicted in FIGS. 8 and 9, which are provided for an asymmetrical configuration of the channel system 108 and/or the valves 124 and 126, correspond to the control method depicted in FIG. 4, which is provided for a symmetrical configuration of the channel system 108 and the two valves 124 and 126 with respect to flow.

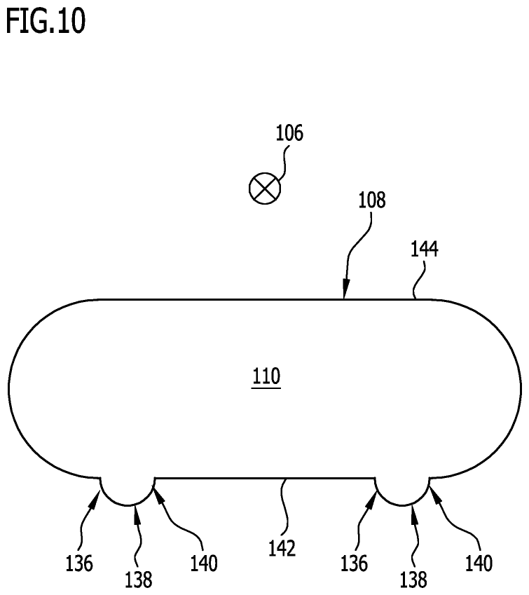

A second embodiment of a fuel cell system, of which only a cross section through the medium channel 110 of the channel system 108 is depicted in FIG. 10, which cross section corresponds to the cross section from FIG. 2 for the first embodiment of the fuel cell system 100, differs from the above-described first embodiment of the fuel cell system 100 in that not only one water compensation channel 136 is provided, which connects the first water collection region 112 and the second water collection region 114 to one another and comprises a smooth-flow region 138, but instead two or more water compensation channels 136 are provided, which each comprise a smooth-flow region 138 that is configured in each case, for example, as a protrusion 140 in the base region 142 of a delimitation 144 of the medium channel 110.

In all other respects, the second embodiment of a fuel cell system 100 depicted in FIG. 10 corresponds with respect to structure, function, and production method with the first embodiment depicted in FIGS. 1 to 3, to the preceding description of which reference is made in this regard.

Each of the control methods for the operation of the fuel cell system 100 that has been described above with reference to FIGS. 4 to 9 can also be performed with the second embodiment of a fuel cell system 100 depicted in FIG. 10.

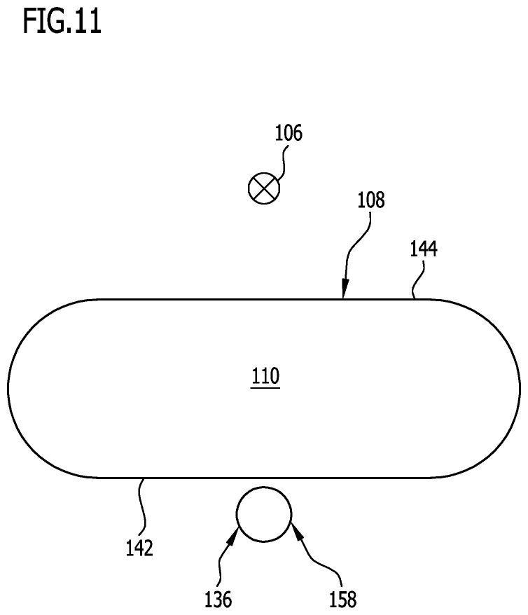

A third embodiment of a fuel cell system, of which only a cross section through the medium channel 110 of the channel system 108 is depicted in FIG. 11, which cross section corresponds to the cross section from FIG. 2 through the medium channel 110 of the first embodiment of the fuel cell system 100, differs from the first embodiment of the fuel cell system 100 in that the water compensation channel 136 by which the first water collection region 112 and the second water collection region 114 are connected to one another comprises, alternatively or in addition to a smooth-flow region 138 of the medium channel 110, a water compensation line 158 formed separately from the medium channel 110.

The water compensation line 158 extends preferably from the first water collection region 112 to the second water collection region 114.

In all other respects, the third embodiment of a fuel cell system 100 depicted in FIG. 11 corresponds with respect to structure, function, and production method with the first embodiment depicted in FIGS. 1 to 3, to the preceding description of which reference is made in this regard.

All methods described above and depicted in FIGS. 4 to 9 for controlling a fuel cell system 100 are performable with this third embodiment of a fuel cell system 100, too.

1. A fuel cell system, comprising at least one fuel cell stack and a channel system for at least one of i) supplying a fluid medium to the fuel cell stack and ii) discharging a fluid medium from the fuel cell stack,
a first water collection region in which water collects in a first range of operating positions of the fuel cell system, and
a first water discharge port by which water is able to be discharged from the first water collection region,
wherein the fuel cell system comprises at least one second water collection region in which water collects in a second range of operating positions of the fuel cell system, and
a least one second water discharge port by which water is able to be discharged from the second water collection region.

2. The fuel cell system in accordance with claim 1, wherein the second operating position range comprises at least one second operating position partial range in which no water collects in the first water collection region.

3. The fuel cell system in accordance with claim 2, wherein in the second operating position partial range, the lowest point of the channel system is located in the second water collection region.

4. The fuel cell system in accordance with claim 1, wherein the first operating position range comprises at least one first operating position partial range in which no water collects in the second water collection region.

5. The fuel cell system in accordance with claim 4, wherein in the first operating position partial range, the lowest point of the channel system is located in the first water collection region.

6. The fuel cell system in accordance with claim 1, wherein the first operating position range and the second operating position range together comprise all operating positions of the fuel cell system.

7. The fuel cell system in accordance with claim 1, wherein the first water discharge port is arranged closer to an anode end plate of the fuel cell stack than to a cathode end plate of the fuel cell stack.

8. The fuel cell system in accordance with claim 1, wherein the second water discharge port is arranged closer to a cathode end plate of the fuel cell stack than to an anode end plate of the fuel cell stack.

9. The fuel cell system in accordance with claim 1, wherein at least one of i) the first water discharge port and ii) the second water discharge port is connected to a channel system for supplying an anode gas to the fuel cell stack or to a channel system for discharging an anode gas from the fuel cell stack.

10. The fuel cell system in accordance with claim 1, wherein at least one of i) the first water discharge port and ii) the second water discharge port is connected to a channel system for supplying a cathode gas to the fuel cell stack or to a channel system for discharging a cathode gas from the fuel cell stack.

11. The fuel cell system in accordance with claim 1, wherein a gaseous medium is at least one of i) able to be discharged from the respectively associated channel system and ii) suppliable to the respectively associated channel system by at least one of i) the first water discharge port and ii) the second water discharge port.

12. The fuel cell system in accordance with claim 1, wherein the fuel cell system comprises a device for determining an operating position of the fuel cell system and a control apparatus, which comprises at least one of i) a first valve for closing the first water discharge port and ii) a second valve for closing the second water discharge port in dependence on the determined operating position.

13. The fuel cell system in accordance with claim 1, wherein the fuel cell system comprises a device for determining a filling state of at least one of i) the first water collection region and ii) the second water collection region and comprises a control apparatus, which controls at least one of i) a first valve for closing the first water discharge port and ii) a second valve for closing the second water discharge port in dependence on at least one of i) the determined filling state of the first water collection region and ii) the determined filling state of the second water collection region.

14. The fuel cell system in accordance with claim 1, wherein the first water collection region and the second water collection region are connected to one another by at least one water compensation channel.

15. The fuel cell system in accordance with claim 14, wherein at least one water compensation channel is configured as a smooth-flow region of a medium channel of a channel system of the fuel cell system.

16. The fuel cell system in accordance with claim 14, wherein at least one water compensation channel is configured as a water compensation line formed separately from a medium channel of a channel system of the fuel cell system.

17. A method for discharging water from a fuel cell system, comprising the following:
collecting water in a first water collection region when the fuel cell system is in a first range of operating positions;
collecting water in a second water collection region when the fuel cell system is in a second range of operating positions;
discharging water from the first water collection region by way of a first water discharge port;
discharging water from the second water collection region by way of a second water discharge port.
